(19) United States
(12) Patent Application Publication
(10) Pub. No.: US 2021/0259231 A1
(43) Pub. Date: Aug. 26, 2021

(54) AMBULATORY INSECT PEST-TRAPPING DEVICE

(71) Applicant: KURARAY TRADING CO., LTD., Osaka-shi (JP)

(72) Inventor: Eiji AKIBA, Osaka-shi (JP)

(73) Assignee: KURARAY TRADING CO., LTD., Osaka-shi (JP)

(21) Appl. No.: 17/252,505

(22) PCT Filed: Jun. 28, 2019
(86) PCT No.: PCT/JP2019/025864

§ 371 Date: Dec. 15, 2020

(30) Foreign Application Priority Data
Jul. 5, 2018 (JP) 2018-128595

(51) Int. Cl. A01M 1/14; A01M 1/10; A01M 1/02

(52) U.S. Cl. CPC A01M 1/14; A01M 2200/011; A01M 1/02; A01M 1/103

(57) ABSTRACT

The ambulatory insect pest-trapping device includes a contact portion at which one end of an adhesive sheet is connected to one end of a walkway sheet. Another end of the adhesive sheet is arranged apart from another end of the walkway sheet. A space for housing an ambulatory insect pest B is formed between the adhesive sheet and the walkway sheet, and an entrance is formed between the other end of the adhesive sheet and the other end of the walkway sheet. The device is formed into a tapered shape such that a distance between the adhesive sheet and the walkway sheet gradually decreases in a direction from the entrance toward the contact portion.

### TECHNICAL FIELD

The present invention relates to an ambulatory insect pest-trapping device that traps ambulatory insect pests such as bed bugs with an adhesive surface.

### BACKGROUND ART

Bed bugs (formerly also called “Nankinmushi”) are blood-sucking insects. Among them, the drug-resistant ones have been recently increasing in number, causing damage in accommodation facilities and homes.

Generally, examples of methods commonly applied to exterminate bed bugs includes disinfestation performed by a professional exterminator using a powerful agent, disinfestation of treating furniture infested with bed bugs by using boiling water, etc. However, these methods require great efforts.

In view of this, there have been proposed devices for trapping bed bugs. For example, there has been proposed a trapping device having a corrugated plate processed into a wave-like form and an adhesive body having an adhesive surface that faces and is adhered to wave-like ridges of the corrugated plate. The trapping device includes a bed bug entrance portion between the adhesive surface of the adhesive body and the wave-like ridges of the corrugated plate (see, for example, Patent Document 1). There has been proposed a further trapping device including an attractant, a retraction portion, and an opening. The trapping device further includes a casing with an inner space in which the attractant is arranged. The retraction portion is arranged on the casing and has a path on which bed bugs are capable of walking. The opening is arranged to be adjacent to the retraction portion and is formed on at least one of wall surfaces of the casing (see, for example, Patent Document 2).

Further, ambulatory insect pests also include ants, cockroaches, mites, centipedes, and millipedes that may bite or sting humans, causing harm to a human body. In addition, there are insect pests that have little direct adverse effect on a human body, but bring a sense of discomfort. Also against these insect pests, there have been proposed various pest control methods and trapping devices.

### CITATION LIST

### Patent Documents

Patent Document 1: Japanese Unexamined Patent Publication No. 2014-64499

Patent Document 2: Japanese Unexamined Patent Publication (Japanese Translation of PCT Application) No. 2013-544514

### SUMMARY OF THE INVENTION

### Technical Problem

Patent Document 1 discloses a bed bug trapping device that traps bed bugs by causing legs of bed bugs to stick to an adhesive surface. However, a contact area between the legs of bed bugs and the adhesive surface is small, which may disadvantageously result in insufficient adhesive strength, making it difficult to trap bed bugs. In addition, there has also been known a problem that trapping bed bugs itself is difficult since bed bugs tend to avoid stepping on the adhesive surface.

Further, Patent Document 2 discloses a bed bug trapping device using an attractant. However, with this device, it is difficult to trapping bed bugs since bed bugs hardly fall into a fall-trap.

Therefore, the present invention has been made in view of the above-described problems, and an object of the present invention is to provide an ambulatory insect pest-trapping device capable of efficiently trapping ambulatory insect pests including bed bugs.

### Solution to the Problem

The present inventors have conducted intensive studies to solve the above-described problems and have completed the present invention. Specifically, the present invention provides the following suitable aspects.

[1] Disclosed is an ambulatory insect pest-trapping device comprising: an upper sheet; an adhesive sheet that is arranged on the upper sheet and configured to come into contact with a back of an ambulatory insect pest; a walkway sheet that is arranged to face the adhesive sheet and on which the ambulatory insect pest walks; a contact portion obtained by connecting one end of the adhesive sheet with one end of the walkway sheet, another end of the adhesive sheet being arranged apart from another end of the walkway sheet; and a space for housing the ambulatory insect pest, the space being formed between the adhesive sheet and the walkway sheet, and an entrance allowing the ambulatory insect to enter the space, the entrance being formed between the other end of the adhesive sheet and the other end of the walkway sheet, the ambulatory insect pest-trapping device being formed into a tapered shape such that a distance between the adhesive sheet and the walkway sheet gradually decreases in a direction from the entrance toward the contact portion.

[2] In the ambulatory insect pest-trapping device of aspect [1], a value of tan θ=H₁/L is 0.01≤tan θ≤0.25 when L is defined as a length of the walkway sheet, and H₁ is defined as a distance between the other end of the adhesive sheet and the other end of the walkway sheet.

[3] Disclosed is an ambulatory insect pest-trapping device comprising: an upper sheet; an adhesive sheet that is arranged on the upper sheet and configured to come into contact with a back of an ambulatory insect pest; a walkway sheet that is arranged to face the adhesive sheet and on which the ambulatory insect pest walks, one end of the adhesive sheet is arranged apart from one end of the walkway sheet, and another end of the adhesive sheet is arranged apart from another end of the walkway sheet; a space for housing the ambulatory insect pest, the space being formed between the adhesive sheet and the walkway sheet, and an entrance allowing the ambulatory insect to enter the space, the entrance being formed between the other end of the adhesive sheet and the other end of the walkway sheet, the ambulatory insect pest-trapping device being formed into a tapered shape such that a distance between the adhesive sheet and the walkway sheet gradually decreases in a direction from the entrance toward the one end of the adhesive sheet and the one end of the walkway sheet.

[4] In the ambulatory insect pest-trapping device of aspect [3], a value of tan θ=(H₁−H₂)/L is 0.01≤tan θ≤0.25, where L is defined as a length of the walkway sheet, H₁ is defined as a distance between the other end of the adhesive sheet and the other end of the walkway sheet, and H₂ is defined as a distance between the one end of the adhesive sheet and the one end of the walkway sheet.

[5] In the ambulatory insect pest-trapping device of any one of aspects [1] to [4], the distance between the other end of the adhesive sheet and the other end of the walkway sheet is 1 mm to 5 mm.

[6] In the ambulatory insect pest-trapping device of any one of aspects [1] to [5], the upper sheet has light-shielding properties.

[7] In the ambulatory insect pest-trapping device of any one of aspects [1] to [5], the upper sheet is light-transparent.

[8] The ambulatory insect pest-trapping device of aspect [7] further comprises a light-shielding member arranged on an outer surface of the upper sheet.

[9] In the ambulatory insect pest-trapping device of aspect [8], the light-shielding member is arranged on the outer surface of the upper sheet such that the shielding properties of the light-shielding member increase in a direction from the entrance toward the contact portion.

[10] In the ambulatory insect pest-trapping device of aspect [8] or [9], the light-shielding member is detachably attached on the outer surface of the upper sheet.

[11] The ambulatory insect pest-trapping device of any one of aspects [1] to [10] further comprises another adhesive sheet arranged on a surface of the walkway sheet at a side opposite to the adhesive sheet.

[12] In the ambulatory insect pest-trapping device of any one of aspects [1] to [11], at least one of the adhesive sheet and the walkway sheet includes an attractant.

[13] In the ambulatory insect pest-trapping device of aspect [12], the attractant is at least one kind selected from the group consisting of octenal, hexenal, hexanone, lactic acid, dimethyl disulfide, and dimethyl trisulfide.

[14] In the ambulatory insect pest-trapping device of any one of aspects [1] to [13], the ambulatory insect pest is a bed bug.

### Advantages of the Invention

According to the present invention, it is possible to reliably trap ambulatory insect pests by bringing their backs into contact with an adhesive sheet, thereby allowing for increase in a contact area between the ambulatory insect pests and an adhesive surface of the adhesive sheet.

### BRIEF DESCRIPTION OF THE DRAWINGS

FIG. 1 is a perspective view illustrating an ambulatory insect pest-trapping device according to an embodiment of the present invention.

FIG. 2 is a cross-sectional view of the ambulatory insect pest-trapping device according to the embodiment of the present invention, taken along the line A-A in FIG.

FIG. 3 is a cross-sectional view of an ambulatory insect pest-trapping device according to a modification of the present invention.

FIG. 4 is a cross-sectional view of an ambulatory insect pest-trapping device according to another modification of the present invention.

FIG. 5 is a cross-sectional view of an ambulatory insect pest-trapping device according to yet another modification of the present invention.

### DETAILED DESCRIPTION OF EMBODIMENT

Hereinafter, an embodiment of the present invention will be described in detail, with reference to the drawings. Note that the present invention is not limited to the embodiment below.

<Ambulatory Insect Pest-Trapping Device>

In the present invention, ambulatory insect pests are defined as insect pests that move by walking and cause harm to a human body by biting or stinging, or ones that have little direct adverse effect on a human body, but bring a sense of discomfort. Examples of ambulatory insect pests include bed bugs, ants, cockroaches, mites, centipedes, millipedes, and the like.

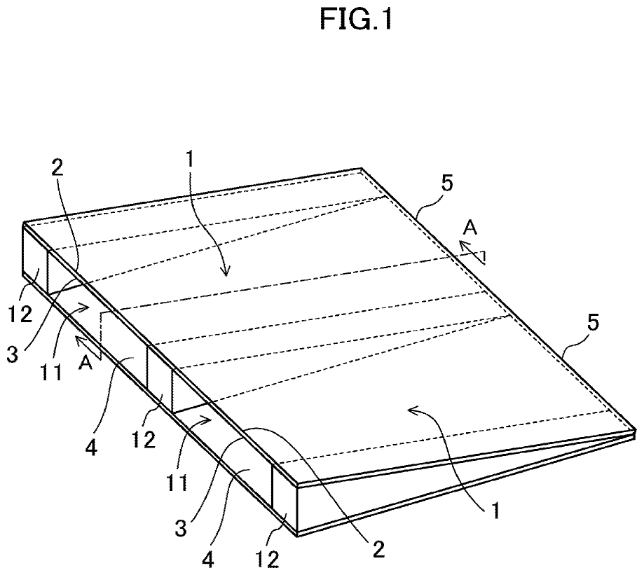

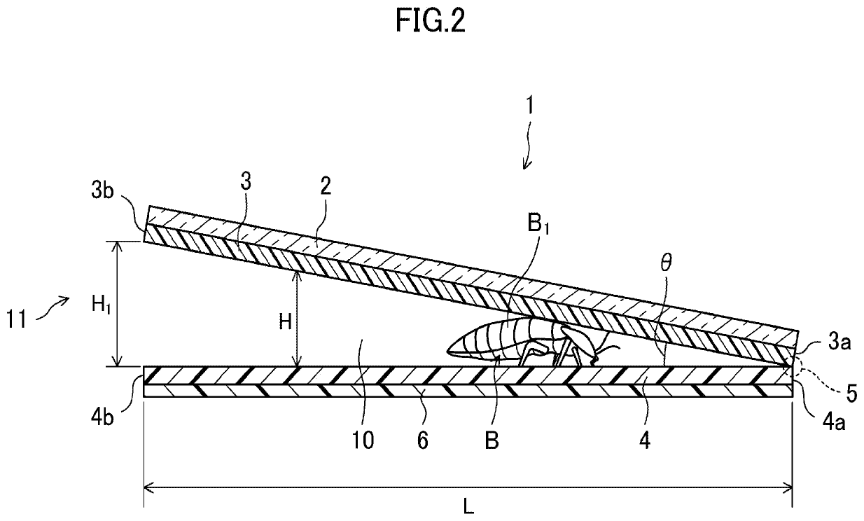

FIG. 1 is a perspective view illustrating an ambulatory insect pest-trapping device according to the embodiment of the present invention, and FIG. 2 is a cross-sectional view illustrating the ambulatory insect pest-trapping device according to the embodiment of the present invention, taken along the line A-A in FIG. 1.

The ambulatory insect pest-trapping device 1 of the present embodiment includes an upper sheet 2, an adhesive sheet 3 that is arranged on the upper sheet 2 and comes into contact with a back B1 of an ambulatory insect B, and a walkway sheet 4 on which the ambulatory insect B walks and which faces the adhesive sheet 3.

As shown in FIG. 2, the ambulatory insect pest-trapping device 1 further includes a contact portion 5 at which one end 3a of the adhesive sheet 3 is connected to one end 4a of the walkway sheet 4. The other end 3b of the adhesive sheet 3 is arranged apart from the other end 4b of the walkway sheet 4.

Further, between the adhesive sheet 3 and the walkway sheet 4, there is formed a space 10 for housing the ambulatory insect pest B. Between the other end 3b of the adhesive sheet 3 and the other end 4b of the walkway sheet 4, there is formed an entrance 11 allowing the ambulatory insect pest B to enter the space 10.

The size of the ambulatory insect pest-trapping device 1 may be appropriately set depending on applications, and is not particularly limited. For example, when the ambulatory insect pest-trapping device 1 is to be inserted between mattresses in a closet, the length L of the ambulatory insect pest-trapping device 1 (that is, the length of the walkway sheet 4) may range from 2 cm to 100 cm. In a view of handleability, disposability, and ensuring of an adhesive trapping surface for an ambulatory insect pests, the length range preferably from 3 cm to 30 cm, and more preferably from 5 cm to 10 cm.

Further, in a case in which the ambulatory insect pest-trapping device 1 is attached, for example, in a vicinity of a bed to trap ambulatory insect pests climbing up from the floor, a plurality of the ambulatory insect pest-trapping devices 1 (two in FIG. 1) with the above-mentioned size may be joined together, as shown in FIG. 1, making it possible to obtain a larger size ambulatory insect pest-trapping devices as a whole.

In addition, a plurality of the ambulatory insect pest-trapping devices 1 may be installed independently (separately) and used.

<Upper Sheet>

The upper sheet 2 evenly holds the adhesive sheet 3, and imparts such a strength to the adhesive sheet 3 that enables handling of the adhesive sheet 3 as a sheet. Examples of a material constituting the upper sheet 2 may include cellulose-based paper, a film consisting of thermoplastic resin such as polyester resin, polyamide resin, polyvinyl chloride resin, polyolefin resin, or acrylic resin, or the like.

The upper sheet 2 is elastic and thin, has good bonding properties with an adhesive agent, is resistant against solvent used in the adhesive agent, and has good dimensional stability. The upper sheet 2 may have light-shielding properties or be light-transparent. Examples of the sheet having light-shielding properties may include a sheet of paper and a film that are colored in a black or any other medium-dark color.

As a light-transparent sheet, a transparent film including thermoplastic resin such as polyester resin, polyamide resin, polyvinyl chloride resin, polyolefin resin, or acrylic resin may be used.

The upper sheet 2 having light-shielding properties makes it possible to trap ambulatory insect pests such as bed bugs more efficiently that have a habit of preferring dark places, by making use of this habit. On the other hand, when the upper sheet 2 is light-transparent, trapped ambulatory insect pests trapped may be easily visible from the outside of the device.

<Adhesive Sheet>

The adhesive sheet 3 is provided for trapping ambulatory insect pests with its adhesive surface, and is not particularly limited as long as it has appropriate adhesiveness in view of trapping ambulatory insect pests. The adhesive sheet 3 may be formed from, for example, an acrylic-based agent, a rubber-based agent, a SIS block-based agent, or silicon-based adhesive agent. Note that these adhesive agents may be used alone or in combination of two or more.

In view of reliably trapping the ambulatory insect pest B, the adhesive sheet 3 preferably have a high adhesive strength, and is preferably a permanently bonding adhesive sheet that bonds a target to be adhered semipermanently once the adhesive sheet is adhered to the target. A removable adhesive sheet that is to be peeled off after sticking for a certain period of time has relatively worse adhesiveness and may thus be not preferably used.

Moreover, as shown in FIG. 2, the adhesive sheet 3 is configured to come into contact with the back B1 of the ambulatory insect pest B. This allows for increase in the contact area between the ambulatory insect pest B and the adhesive surface of the adhesive sheet 3.

<Walkway Sheet>

The walkway sheet 4 is not particularly limited as long as it is a sheet-like object on which the ambulatory insect pest B may walk. The walkway sheet 4 preferably has moderate irregularities that facilitate walk of ambulatory insect pests, rather than having a smooth surface, and may be a sheet of paper. Further, as shown in FIG. 1, a resin molded sheet integral with a tapered partition member 12 may be used as the walkway sheet 4.

<Attractant>

The adhesive sheet 3 including an attractant may be used as the adhesive sheet 3. The attractant attracts ambulatory insect pests and easily guides them into the space 10. The attractant is not limited as long as it generally has an effect of attracting ambulatory insect pests. In case in which the ambulatory insect pest to be attracted is a bed bug, the attractant may be selected from octenal, hexenal, hexanone, lactic acid, dimethyl disulfide, dimethyl trisulfide, and the like.

Further, these attractants may be contained in the walkway sheet 4 and the tapered partition member 12, for example.

In addition, in case in which the walkway sheet 4 and the tapered partition member 12 are made of a resin, they may include the attractants kneaded into the resin. In this case, the attractants are gradually released from the inside of the resin molded body, advantageously resulting in a longer lasting effect compared with surface-coated attractants.

<Attaching Adhesive Sheet>

As shown in FIG. 2, the ambulatory insect pest-trapping device 1 of this embodiment includes an attaching adhesive sheet 6 on a surface of the walkway sheet 4 that is opposite to the adhesive sheet 3. Therefore, the ambulatory insect pest-trapping device 1 may be easily attached to a wall's surface to be adhered, for example, in case in which the ambulatory insect pest-trapping device 1 is set upright along the wall and attached thereto.

In addition, the attaching adhesive sheet 6 may be formed from at least one adhesive agent such as an acrylic-based adhesive agent that is easily removable. Note that these adhesive agents may be used alone or in combination of two or more.

As shown in FIG. 2, the ambulatory insect pest-trapping device 1 of the embodiment has a tapered shape in which a distance H between the adhesive sheet 3 and the walkway sheet 4 gradually decreases in the direction from the entrance 11 toward the contact portion 5.

The ambulatory insect pest B such as a bed bug has a habit of preferring narrow places. Due to this habit, the ambulatory insect pest B having entered the space 10 from the entrance 11 is likely to move toward a narrow space at the inner side of the space 10 (i.e. the side of the contact portion 5). Accordingly, the back B1 of the ambulatory insect pest B is likely to come into contact with the adhesive sheet 3 of the ambulatory insect pest-trapping device 1 having the tapered shape. As a result, the capture efficiency of the ambulatory insect pest B improves, making it possible to reliably trap the ambulatory insect pest B.

In case in which the ambulatory insect pest B is a bed bug, the height of the entrance 11 (i.e., the distance H₁ between the other end 3b of the adhesive sheet 3 and the other end 4b of the walkway sheet 4) ranges preferably from 1 mm to 5 mm, in order to allow the bed bug to surely enter the space from the entrance 11 in view of the fact that the bed bug has a flat body and a length of 5 mm to 8 mm.

Further, after entering the trapping device 1, the ambulatory insect pest B must walk into the inside of the trapping device 1 until the back B1 of the ambulatory insect B comes into contact with the adhesive sheet 3. In a view of this, the length L of the walkway sheet 4 and the distance H₁ preferably have the relationship expressed in the following formula (1):

[Math 1]

0.01≤tan θ=H₁/L≤0.25 (1)

Note that the length L of the walkway sheet 4 preferably ranges from 2 cm to 100 cm, as described above.

(Method for Manufacturing Ambulatory Insect Pest-Trapping Device)

Next, an example of a method for manufacturing the ambulatory insect pest-trapping device of this embodiment will be described.

The ambulatory insect pest-trapping device 1 may be manufactured in the following manner: First, the attaching adhesive sheet 6 is attached to a back surface of the walkway sheet 4 that is a sheet of black drawing paper. Then, the tapered partition member 12 is attached on the walkway sheet 4. On the resulting walkway sheet 4, there is further attached the upper sheet 2 whose one surface is the adhesive sheet 3 such that the side of the adhesive sheet 3 faces the walkway sheet 4.

Note that the embodiment may be modified as described below.

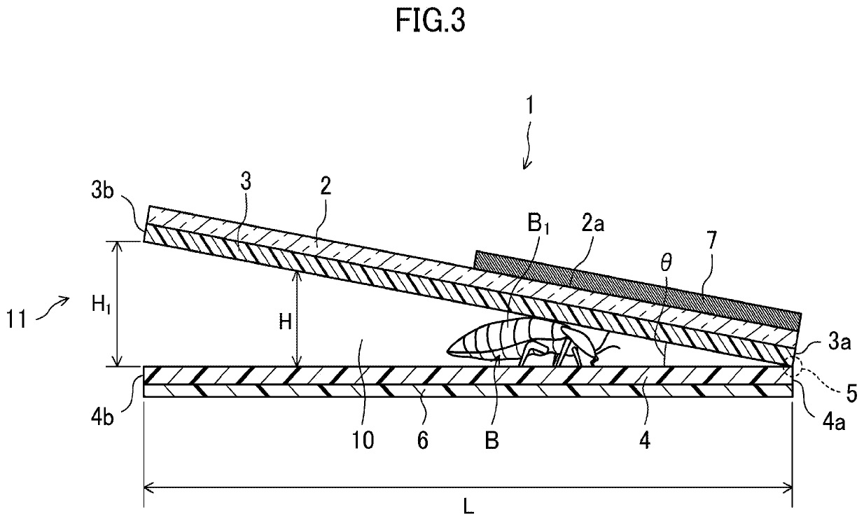

Among ambulatory insect pests, bed bugs in particular have a habit of preferring dark places. For this reason, in case in which the upper sheet 2 is light-transparent, a light-shielding member 7 may be arranged on an outer surface 2a of the upper sheet 2 at the side of the contact portion 5, as shown in FIG. 3. With this configuration, a bed bug having entered the space 10 from the entrance 11 is likely to move toward the inner side of the space 10 (i.e., the side of the contact portion 5) that is darker place. Accordingly, the back B1 of the bed bug is likely to come into contact with the adhesive sheet 3 of the ambulatory insect pest-trapping device 1 having the tapered shape. As a result, the capture efficiency of bed bugs further improves.

Further, the light-shielding member 7 having shielding properties increasing in the direction from the entrance 11 toward the contact portion 5 may be arranged on the outer surface 2a of the upper sheet 2. In this case, it is possible to provide a single light-shielding member 7 or a plurality of light-shielding members 7.

For example, a first light-shielding member 7 may be provided on the outer surface 2a of the upper sheet 2 at the side of the entrance 11 and, at the same time, a second light-shielding member 7 having higher shielding properties than the first light-shielding member 7 may be provided on the outer surface 2a at the side of the contact portion 5.

The light-shielding member 7 is not particularly limited as long as it shields light. Examples of the light-shielding member having high light-shielding properties may include a film, a sheet of paper and a film that are colored in a black or any other medium-dark color. Examples of the light-shielding member having low light-shielding properties may include a sheet of paper, a film and a sheet that are colored in a white or any other light color.

Further, in case in which the upper sheet 2 is light-transparent, the light-shielding member 7 may be detachably attached to the outer surface 2a of the upper sheet 2 so that ambulatory insect pests trapped are easily visible from the outside of the device.

Further, cross-sectional shapes of the upper sheet 2 and the adhesive sheet 3 are not limited as long as the ambulatory insect pest-trapping device has a tapered shape in which the distance H between the adhesive sheet 3 and the walkway sheet 4 gradually decreases in the direction from the entrance 11 toward the contact portion 5.

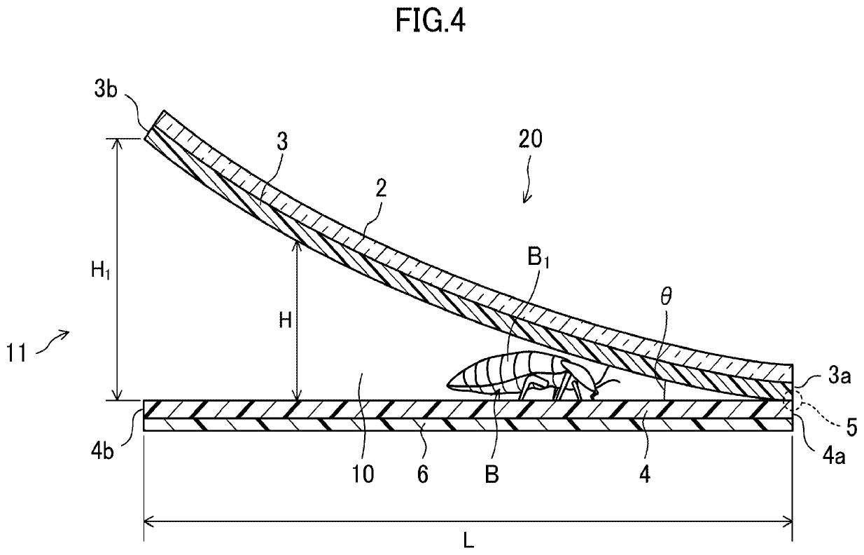

For example, the cross sections of the upper sheet 2 and the adhesive sheet 3 may be curved as in the case of an ambulatory insect pest-trapping device 20 shown in FIG. 4.

This configuration also allows for the same effects as those of the ambulatory insect pest-trapping device 1 of the above-described embodiment.

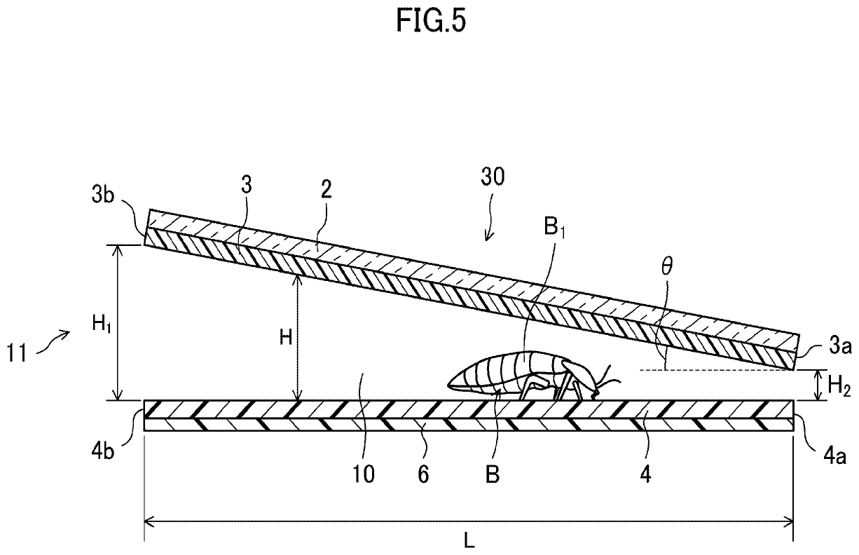

Further, the one end 3a of the adhesive sheet 3 and the one end 4a of the walkway sheet 4 may be arranged apart from each other, as in the case of an ambulatory insect pest-trapping device 30 shown in FIG. 5.

In this case, as shown in FIG. 5, the ambulatory insect pest-trapping device 30 has a tapered shape in which the distance H between the adhesive sheet 3 and the walkway sheet 4 gradually decreases in the direction from the entrance 11 toward the one end 3a of the adhesive sheet 3 and the one end 4a of the walkway sheet 4.

A distance H₂ between the one end 3a of the adhesive sheet 3 and the one end 4a of the walkway sheet 4 is preferably equal to or less than 1 mm, in view of preventing ambulatory insect pests B that have entered the trap from escaping from a space between the one end 3a of the adhesive sheet 3 and the one end 4a of the walkway sheet 4.

Further, as in the case of the ambulatory insect pest-trapping device 1 of the above embodiment, the ambulatory insect pest B having entered the trapping device 30, must proceed toward the inside of the trapping device 30 until its back B₁ comes into contact with the adhesive sheet 3. In view of this, the length L of the walkway sheet 4, the distance H₁, and the distance H₂ between the one end 3a of the adhesive sheet 3 and the one end 4a of the walkway sheet 4 preferably have a relationship expressed by the following formula (2):

[Math 2]

0.01≤tan θ=(H₁−H₂)/L≤0.25 (2)

This configuration also allows for the same effects as those of the ambulatory insect pest-trapping device 1 of the above-described embodiment.

Further, the ambulatory insect pest-trapping device 30 shown in FIG. 5 may be provided with a light-shielding member 7 on the outer surface 2a of the upper sheet 2 at the side of the one end 3a of the adhesive sheet 3 (or at the side of the one end 4a of the walkway sheet 4), in the same manner as the ambulatory insect pest-trapping device 1 shown in FIG. 3.

Further, the light-shielding member 7 having shielding properties increasing in a direction from the entrance 11 toward the contact portion 5 of the upper sheet 2 may be provided on the outer surface 2a of the upper sheet 2. Alternatively, the light-shielding member 7 detachably attached to the outer surface 2a of the upper sheet 2 may be provided.

In addition, the cross sections of the upper sheet 2 and the adhesive sheet 3 may be curved in the case of the ambulatory insect pest-trapping device 30 shown in FIG. 5, in the same manner as in the ambulatory insect pest-trapping device 20 shown in FIG. 4.

### EXAMPLES

Hereinafter, the present invention will be described based on examples. Note that the present invention shall not be limited to these examples. These examples may be modified and changed based on the concept of the present invention. Such changes and modifications shall not be excluded from the scope of the invention.

### Example 1

(Manufacturing of Ambulatory Insect Pest-trapping Device) A commercially available black cardboard (having a thickness of 0.78 mm) was cut into a dimension of 5 cm×5 cm to produce a walkway sheet. A double-sided adhesive sheet (commercially available product) was cut into a dimension of 5 cm×5 cm and attached to the walkway sheet to produce an attaching adhesive sheet

Further, a transparent film (manufactured by Toray Industries Inc., Trade Name: Lumirror T60, thickness: 75 μm) was cut into a dimension of 5 cm×5 cm to form an upper sheet. A double-sided adhesive sheet (manufactured by Techno Flow One Inc., Trade Name: TC5510) was cut into a dimension of 5 cm×5 cm, attached to the upper sheet, resulting in an adhesive sheet.

Further, a wedge-like molded body having a truncated square pyramid with a length of 50 mm, one surface with a dimension of 5 mm×5 mm and the other surface with a dimension of 5 mm×0.1 mm, was manufactured by a 3D printer using a black filament, resulting in a tapered partition member.

Next, three pieces of the tapered partition members were attached to the walkway sheet using adhesive tapes at the side opposite from the attaching adhesive sheet at regular intervals starting from one edge of the walkway sheet. Further, the adhesive sheet of the upper sheet was attached on the tapered partition members 12.

Further, a commercially available cardboard (having a thickness of 0.4 mm and cut in a dimension of 5 cm×5 cm) as a light-shielding member was attached on an outer surface of the upper sheet at the side of the contact portion. In this way, the ambulatory insect pest-trapping device shown in FIG. 3 was manufactured.

Note that in the manufactured ambulatory insect pest-trapping device, the length L of the walkway sheet was 50 mm, the distance H₁ was 5 mm, and tan θ was 0.1.

(Capture Evaluation)

Next, a sheet of filter paper was laid on a floor surface of a rectangular plastic container with a capacity of 5200 mL, and the ambulatory insect pest-trapping devices manufactured (in this case, two) were attached to the plastic container via the attaching adhesive sheet on the bottom surface of the trapping device.

Next, ten bed bugs were put into a plastic container. Under the condition with a room temperature of 21° C. to 25° C. and a relative humidity of 15% to 32%, indoor lighting was turned on for 12 hours, and off for 12 hours, repeatedly, until 48 hours have elapsed. After 48 hours, the number of bed bugs trapped in the adhesive part of the ambulatory insect pest-trapping device was checked.

Then, the capture rate of bed bugs was calculated using the following formula (3). Note that the above process was performed three times, and the average value taken from the three capture rates are shown in Table 1.

[Math 3]

Capture rate (%)=(number of trapped bed bugs/number of bed bugs in the container)×100 (3)

### Example 2

The ambulatory insect pest-trapping device was manufactured in the same manner as in Example 1, except that lactic acid as an attractant was blended in an amount of 0.5% in the adhesive portion of the double-sided adhesive sheet attached to the upper sheet. Thereafter, the capture evaluation was performed in the same manner as in Example 1. The results thus obtained are shown in Table 1.

### Example 3

The ambulatory insect pest-trapping device was manufactured in the same manner as in Example 1 except the following: A commercially available cardboard having high light-shielding properties (having a thickness of 0.4 mm, and cut into a dimension of 5 cm×2.5 cm) was attached to the outer surface of the upper sheet at the side of the contact portion, as shown in FIG. 3. A sheet of copy paper having low-light shielding properties (white color, having a thickness of 0.09 mm, and cut into a dimension of 5 cm×2.5 cm) was attached on the top of the outer surface of the upper sheet at the side of the entrance (i.e., in the portion where the cardboard was not attached). Thereafter, the capture evaluation was performed in the same manner as in Example 1. The results thus obtained are shown in Table 1.

### Example 4

The ambulatory insect pest-trapping device was manufactured in the same manner as in Example 1, except that no cardboard that is a light-shielding member was attached on the outer surface of the upper sheet. Thereafter, the capture evaluation was performed in the same manner as in Example 1. The results thus obtained are shown in Table 1.

### Example 5

The ambulatory insect pest-trapping device was manufactured in the same manner as in Example 1, except that a molded body that was formed into a truncated square pyramid shape with a length of 100 mm, and had one surface with a dimension of 5 mm×5 mm, the other surface with a dimension of 5 mm×4 mm, was manufactured with a 3D printer using a black filament. In this way, a tapered partition member was obtained. Thereafter, the capture evaluation was performed in the same manner as in Example 1. The results thus obtained are shown in Table 1.

Note that in the manufactured ambulatory insect pest-trapping device, the length L of the walkway sheet was 100 mm, the distance H₁ was 3 mm, the distance H₂ was 1 mm, and tan θ was 0.02. Thereafter, the capture evaluation was performed in the same manner as in Example 1. The results thus obtained are shown in Table 1.

### Example 6

The ambulatory insect pest-trapping device was manufactured in the same manner as in Example 1, except that a molded body that was formed into a truncated square pyramid shape with a length of 100 mm, and had one surface with a dimension of 5 mm×5 mm, the other surface with a dimension of 5 mm×4 mm, was manufactured with a 3D printer using a black filament. In this way, a tapered partition member was obtained. Thereafter, a detailed evaluation was performed in the same manner as in Example 1. The results thus obtained are shown in Table 1.

In the manufactured ambulatory insect pest-trapping device, the length L of the walkway sheet was 100 mm, the distance H₁ was 5 mm, the distance H₂ was 4 mm, and tan θ was 0.01. Thereafter, the capture evaluation was performed in the same manner as in Example 1. The results thus obtained are shown in Table 1.

### Example 7

In Example 7, the ambulatory insect pest-trapping device was manufactured in the same manner as in Example 1, except that the attractant including hexenal and octenal mixed in a weight ratio of 50/50 was blended in an amount of 40 μg in the resin of the wedge-like molded body. Thereafter, the capture evaluation was performed in the same manner as in Example 1. The results thus obtained are shown in Table 1.

### Example 8

In Example 8, the capture evaluation was performed in the same manner as in Example 1, except that Argentine ants were used as ambulatory insect pests. The results thus obtained are shown in Table 1.

### Example 9

In Example 9, the capture evaluation was performed in the same manner as in Example 1, except that two-spotted spider mites were used as ambulatory insect pests. The results thus obtained are shown in Table 1.

### Example 10

In Example 10 the capture evaluation was performed in the same manner as in Example 1, except that larvae of German cockroaches having a length of 8 mm or less were used as the ambulatory insect pests. The results thus obtained are shown in Table 1.

### Comparative Example 1

The ambulatory insect pest-trapping device was manufactured in the same manner as in Example 1, except that the adhesive sheet was not attached to the upper sheet, and a double-sided adhesive sheet (manufactured by Techno Flow One Inc., Trade Name: TC5510) was cut into a dimension of 5 cm×5 cm and attached to a surface (surface on which ambulatory insect pests walk) of the walkway sheet at the side opposite to the attaching adhesive sheet that is to be used as the adhesive sheet. Thereafter, the capture evaluation was performed in the same manner as in Example 1. The results thus obtained are shown in Table 1.

### Comparative Example 2

A commercially available black cardboard (having a thickness of 0.78 mm) was cut into a dimension of 5 cm×5 cm, thereby obtaining a walkway sheet. A double-sided adhesive sheet (commercially available product) was cut into a dimension of 5 cm×5 cm and attached to this walkway sheet 4 to be used as the attaching adhesive sheet.

Further, a transparent film (manufactured by Toray Industries Inc., Trade Name: Lumirror T60, thickness: 75 μm) was cut into a dimension of 5 cm×5 cm to be an upper sheet. A double-sided adhesive sheet (manufactured by Techno Flow One Inc., Trade Name: TC5510) was cut into a dimension of 5 cm×5 cm and attached to the upper sheet to be used as an adhesive sheet.

In addition, a column-like molded body that was formed into a square column shape with a length of 50 mm, and had one surface with a dimension of 5 mm×5 mm, and the other surface with a dimension of 5 mm×5 mm was manufactured with a 3D printer using a black filament. In this way, the parallel partition members not formed into a tapered shape were obtained.

Next, three of the parallel partition members were attached to the walkway sheet using adhesive tapes at the side opposite to the attaching adhesive sheet at even intervals starting from one edge of the walkway sheet. In addition, the adhesive sheet of the upper sheet was attached on the parallel partition members 12.

Further, a commercially available cardboard (having a thickness of 0.4 mm and cut into a dimension of 5 cm×5 cm) as a light-shielding member was attached on an outer surface of the upper sheet. In this way, a parallel-type ambulatory insect pest-trapping device not formed into a tapered shape was obtained. Thereafter, the capture evaluation was performed in the same manner as in Example 1. The results thus obtained are shown in Table 1.

TABLE 1

| | | | Capture |
|---|---|---|---|
| | Ambulatory Insect Pest | Attractant | Rate (%) |
| Example 1 | Beg Bug | No | 48 |
| Example 2 | Bed Bug | Lactic Acid | 60 |
| Example 3 | Bed Bug | No | 53 |
| Example 4 | Bed Bug | No | 10 |
| Example 5 | Bed Bug | No | 41 |
| Example 6 | Bed Bug | No | 6 |
| Example 7 | Bed Bug | Hexenal | 85 |
| | | Octenal | |
| Example 8 | Argentine Ant | No | 9 |
| Example 9 | Two-spotted Spider Mite | No | 6 |
| Example 10 | Larva of German Cockroach | No | 14 |
| Comparative | Bed Bug | No | 0 |
| Example 1 | | | |
| Comparative | Bed Bug | No | 0 |
| Example 2 | | | |

As shown in Table 1, in the ambulatory insect pest-trapping device of Example 1, a large number of bed bugs was efficiently trapped. In Example 2, the attractant was blended. Thus, a larger number of bed bugs was trapped than that of Example 1. In Example 3, the space of the ambulatory insect pest-trapping device becomes darker in the direction from the entrance toward the back side of the space (i.e., toward the contact portion). Therefore, more bed bugs can be lured to the back side of the space 10 that is darker. Thus, the bed bugs were trapped more efficiently as compared to Example 1. In Example 4, the light was not blocked. Hence, the number of trapped bed bugs was smaller than those of Examples 1 to 3 in which light was blocked. Still, it was possible to trap bed bugs. In Example 5, there was a distance between one end of the adhesive sheet and one end of the walkway sheet. Still, it was possible to efficiently trap bed bugs. In Example 6, the distance between the one end of the adhesive sheet and the one end of the walkway sheet is large. Hence, small bed bugs were able to get away. Thus, the number of trapped bed bugs was smaller than those of Examples 1 to 3 in which there is no distance and Example 5 in which the distance is small. Still, it was possible to trap bed bugs.

Further, in Example 7, a capture rate as high as 85% was achieved by the use of the attractant (including hexenal and octenal).

In Example 8, Argentine ants were used, in Example 9, two-spotted spider mites were used, and in Example 10, larvae of German cockroaches having a length of 8 mm or less were used as ambulatory insect pests. As can be seen from the capture evaluations, it was also possible to trap these ambulatory insect pests. In this way, it was possible to confirm a versatility of the ambulatory insect pest-trapping device of the present invention.

On the other hand, in Comparative Example 1, there was no adhesive sheet on the upper sheet, and the contact area between the legs of bed bugs and the adhesive face was small on the adhesive sheet of the walkway sheet. Further, Bed bugs could hardly enter the adhesive surface portion. Accordingly, it was not possible to trap bed bugs. In Comparative Example 2, the distance between the adhesive sheet and the walkway sheet remains constant from the entrance to the back side. Accordingly, bed bugs indeed entered the trapping device, but their backs did not reach the adhesive surface above them. Therefore, it was not possible to trap bed bugs.

### INDUSTRIAL APPLICABILITY

As described above, the present invention is particularly useful as an ambulatory insect pest-trapping device for trapping ambulatory insect pests with an adhesive surface.

### DESCRIPTION OF REFERENCE CHARACTERS

1 Ambulatory Insect Pest-trapping Device
2 Upper Sheet
2A Outer Surface of Upper Sheet
3 Adhesive Sheet
3a One End of Adhesive Sheet
3b Other End of Adhesive Sheet
4 Walkway Sheet
4a One End of Walkway Sheet
4b Other End of Walkway Sheet
5 Contact Portion
6 Attaching Adhesive Sheet (Another Adhesive Sheet)
7 Light-shielding Member
10 Space
11 Entrance
12 Tapered Partition Member
20 Ambulatory Insect Pest-trapping Device
30 Ambulatory Insect Pest-trapping Device
B Ambulatory Insect Pest
B1 Back of Ambulatory Insect Pest
H₁ Distance between Other End of Adhesive Sheet and Other End of Walkway Sheet
H₂ Distance between One End of Adhesive Sheet and One End of Walkway Sheet
L Length of Walkway Sheet

1. An ambulatory insect pest-trapping device comprising:
an upper sheet;
an adhesive sheet that is arranged on the upper sheet and configured to come into contact with a back of an ambulatory insect pest;
a walkway sheet that is arranged to face the adhesive sheet and on which the ambulatory insect pest walks;
a contact portion obtained by connecting one end of the adhesive sheet with one end of the walkway sheet, another end of the adhesive sheet being arranged apart from another end of the walkway sheet; and
a space for housing the ambulatory insect pest, the space being formed between the adhesive sheet and the walkway sheet, and an entrance allowing the ambulatory insect to enter the space, the entrance being formed between the other end of the adhesive sheet and the other end of the walkway sheet,
the ambulatory insect pest-trapping device being formed into a tapered shape such that a distance between the adhesive sheet and the walkway sheet gradually decreases in a direction from the entrance toward the contact portion.

2. The ambulatory insect pest-trapping device of claim 1, wherein
a value of tan θ=H₁/L is 0.01≤tan θ≤0.25 when L is defined as a length of the walkway sheet, and H₁ is defined as a distance between the other end of the adhesive sheet and the other end of the walkway sheet.

3. An ambulatory insect pest-trapping device comprising:
an upper sheet;
an adhesive sheet that is arranged on the upper sheet and configured to come into contact with a back of an ambulatory insect pest;
a walkway sheet that is arranged to face the adhesive sheet and on which the ambulatory insect pest walks, one end of the adhesive sheet being arranged apart from one end of the walkway sheet, another end of the adhesive sheet being arranged apart from another end of the walkway sheet; and
a space for housing the ambulatory insect pest, the space being formed between the adhesive sheet and the walkway sheet, and an entrance for allowing the ambulatory insect to enter the space, the entrance being formed between the other end of the adhesive sheet and the other end of the walkway sheet,
the ambulatory insect pest-trapping device being formed into a tapered shape such that a distance between the adhesive sheet and the walkway sheet gradually decreases in a direction from the entrance toward the one end of the adhesive sheet and the one end of the walkway sheet.

4. The ambulatory insect pest-trapping device of claim 3, wherein
a value of tan θ=(H₁−H₂)/L is 0.01≤tan θ≤0.25, where L is defined as a length of the walkway sheet, H₁ is defined as a distance between the other end of the adhesive sheet and the other end of the walkway sheet, and H₂ is defined as a distance between the one end of the adhesive sheet and the one end of the walkway sheet.

5. The ambulatory insect pest-trapping device of claim 1, wherein
the distance between the other end of the adhesive sheet and the other end of the walkway sheet is 1 mm to 5 mm.

6. The ambulatory insect pest-trapping device of claim 1, wherein
the upper sheet has light-shielding properties.

7. The ambulatory insect pest-trapping device of claim 1, wherein
the upper sheet is light-transparent.

8. The ambulatory insect pest-trapping device of claim 7, further comprising
a light-shielding member arranged on an outer surface of the upper sheet.

9. The ambulatory insect pest-trapping device of claim 8, wherein
the light-shielding member is arranged on the outer surface of the upper sheet such that the shielding properties of the light-shielding member increase in a direction from the entrance toward the contact portion.

10. The ambulatory insect pest-trapping device of claim 8, wherein
the light-shielding member is detachably attached on the outer surface of the upper sheet.

11. The ambulatory insect pest-trapping device of claim 1, further comprising
another adhesive sheet arranged on a surface of the walkway sheet at a side opposite to the adhesive sheet.

12. The ambulatory insect pest-trapping device of claim 1, wherein
at least one of the adhesive sheet and the walkway sheet includes an attractant.

13. The ambulatory insect pest-trapping device of claim 12, wherein
the attractant is at least one kind selected from the group consisting of octenal, hexenal, hexanone, lactic acid, dimethyl disulfide, and dimethyl trisulfide.

14. The ambulatory insect pest-trapping device of claim 1, wherein
the ambulatory insect pest is a bed bug.

15. The ambulatory insect pest-trapping device of claim 3, wherein
the distance between the other end of the adhesive sheet and the other end of the walkway sheet is 1 mm to 5 mm.

16. The ambulatory insect pest-trapping device of claim 3, wherein
the upper sheet has light-shielding properties.

17. The ambulatory insect pest-trapping device of claim 3, wherein
the upper sheet is light-transparent.

18. The ambulatory insect pest-trapping device of claim 17, further comprising
a light-shielding member arranged on an outer surface of the upper sheet.

19. The ambulatory insect pest-trapping device of claim 18, wherein
the light-shielding member is arranged on the outer surface of the upper sheet such that the shielding properties of the light-shielding member increase in a direction from the entrance toward the contact portion.

20. The ambulatory insect pest-trapping device of claim 18, wherein
the light-shielding member is detachably attached on the outer surface of the upper sheet.

21. The ambulatory insect pest-trapping device of claim 3, further comprising
another adhesive sheet arranged on a surface of the walkway sheet at a side opposite to the adhesive sheet.

22. The ambulatory insect pest-trapping device of claim 3, wherein
at least one of the adhesive sheet and the walkway sheet includes an attractant.

23. The ambulatory insect pest-trapping device of claim 22, wherein
the attractant is at least one kind selected from the group consisting of octenal, hexenal, hexanone, lactic acid, dimethyl disulfide, and dimethyl trisulfide.

24. The ambulatory insect pest-trapping device of claim 3, wherein
the ambulatory insect pest is a bed bug.
